(19) United States
(12) Patent Application Publication
(10) Pub. No.: US 2002/0174101 A1
(43) Pub. Date: Nov. 21, 2002

(54) Document retrieval system

(76) Inventors: Helen Elaine Penelope Fernley, Manchester (GB); Thomas Brendan Berney, Manchester (GB)

Correspondence Address: Thomas Q Henry, Woodard Emhardt Naughton Moriarty & McNett, Bank One Tower Suite 3700, 111 Monument Circle, Indianapolis, IN, 46204, US

(21) Appl. No.: 10/070,810

(22) PCT Filed: Jul. 9, 2001
(86) PCT No.: PCT/GB01/03087

(30) Foreign Application Priority Data
Jul. 12, 2000 (GB) 0016974.8

(51) Int. Cl. G06F 7/00

(52) U.S. Cl. 707/1

(57) ABSTRACT

A document retrieval system comprising a user interface and processing means, wherein the user interface is configured to allow a user to enter a query phrase indicative of a subject of interest, and the processing means is operative to select query keywords from the query phrase and allocate weightings to the query keywords dependent upon the relative positions of the query keywords within the query phrase.

The present invention relates to a document retrieval system, and relates in part to a method of summarising the contents of a document.

Information retrieval may be said to have one major goal, the retrieval of highly pertinent information from data sources. This goal may be split two major objectives: document indexing, the process by which documents may be collected together and prepared to allow for swift and precise retrieval; and document retrieval, the process by which documents present in a collection may be retrieved to fulfil a user's information need.

Early automated document retrieval systems relied on simple feature matching using fields and keywords. Such systems compared query keywords with a database of documents, and returned documents containing those keywords. These systems were later extended to allow the use of Boolean logic for more meaningful query specification.

Information retrieval systems based upon the use of keywords tend to be aimed at retrieving information with well defined semantic content (such as text relating to a specific subject), where a user has a definite idea of what they are looking for and is able to formulate a detailed query with a small number of possible expected results.

The need to retrieve information from sets of large documents with much broader semantic contents has led to the development of systems that can deal with less specific queries and are capable of returning possible candidates relating to what a user asked for, in ranked order of perceived usefulness (relevance ranking).

In order to allow a ranking of results, it is necessary to augment the simple keyword matching method with methods which represent the overall importance of a particular query keyword within retrieved documents. Within the field of information retrieval this was first achieved by the SMART Retrieval System [Salton and McGill, Introduction to Modem Information Retrieval, 1983], where documents are represented by sets of keyword features each having a numerical weighting representing their overall importance within he document. Within this system, documents are prepared for indexing by finding the most frequently occurring keywords and assigning weight values to them, based upon their frequency of occurrence within a specific document versus their overall frequency of occurrence in the document collection This scheme, known as Term Frequency * Inverse Document Frequency (TF/IDF) has the effect of giving keywords that occur frequently in a particular document (and that are peculiar to that document) a high weighting whilst lowering the weights of universally occurring keywords such as ‘the’ or ‘and’.

The resulting document signature is viewed as a vector of terms with associated weights, and as such occupies a multi-dimensional space within the features of all documents in the collection. As queries and documents may both be prepared and represented in this way, it was found that it was possible to measure the similarity between queries and documents trigonometrically, using vector-space analysis [Salton and McGill, 1983]. Under this scheme, the query vector is compared with each document vector in the collection using the formula:

$$Similarity ( {Q}_{i} , {D}_{j} ) = \frac{{\sum }_{k = 1}^{t} ( {w}_{jk} {w}_{ik} )}{\sqrt{{\sum }_{k = 1}^{t} ( {w}_{ik}^{2} ) \times {\sum }_{k = 1}^{t} ( {w}_{jk}^{2} )}}$$

Where Qᵢ is a query vector comprising a set of weights wᵢₖ and Dⱼ is a document vector comprising, a set of weights wⱼₖ. The formula is a ‘cosine’ vector similarity measure, and provides the cosine angle between the query vector and the document vector.

For each document-query comparison, a score is produced representing the similarity or relevance of the document to the query. During the retrieval process, documents are retrieved and presented in descending order of relevance to the query.

There has been considerable research into the application of artificial intelligence and learning to the retrieval process. This research has spawned the area of connectionist information retrieval. Under this information retrieval paradigm, rather than indexing documents, the documents are treated as nodes in a network of weighted links, (usually with weights in the range 0 to 1). These links connect document nodes to query term nodes with varying strengths. The ‘Triggering’ or selection of query terms causes them to ‘fire’ signals along the links. These ‘signals’ may be amplified or attenuated depending upon the weight value of the inks. The signals then feed into the document nodes and will ‘trigger’ them if their sum reaches a certain ‘threshold’ value.

The important aspect of the use of weighted links is that, as the weights between the keywords and documents may be varied according to neural network learning rules, the system is adaptive and incorporates learning approaches based on user feedback as intrinsic functionality.

The use of a set of weighted keywords to retrieve documents, as described above, may not provide a sufficiently specific method of document retrieval, particularly when applied to a set of large documents with broad semantic content.

It is an object of the first aspect of the present invention to provide a document retrieval system which overcomes or mitigates the above disadvantage.

According to a first aspect of the invention there is provided a document retrieval system comprising a user interface and processing means, wherein the user interface is configured to allow a user to enter a query phrase indicative of a subject of interest, and the processing means is operative to select query keywords from the query phrase and allocate positional weightings to the query keywords dependent upon the relative positions of the query keywords within the query phrase.

The inventors have realised that document retrieval may be facilitated by a retrieval system which takes account of the relative positions of keywords. In the English language this is because the most important words of a sentence generally occur towards the end of that sentence.

Preferably, the positional weighting applied to query keywords increases progressively from a low weighting at the beginning of a query phrase to a higher weighting at the end of the query phrase.

Preferably, the positional weighting increases in a substantially linear manner.

Preferably, the positional weightings applied to query keywords are scaled.

Preferably, the scaling is such that the maximum query keyword positional weighting is one.

Preferably, the system is arranged to compare the query phrase with a set of document signature phrases, each document signature phrase being indicative of the contents of a document.

Preferably, each document signature phrase comprises document keywords having positional weightings dependent upon their relative positions within the document signature phrase.

Preferably, comparison of the query phrase and the document signature phrase comprises multiplying the positional weighting of each query keyword by the positional weighting of a corresponding document keyword.

Preferably, the results of the multiplication are added together to provide a sum that is a measure of the relevance of the document represented by the document signature phrase.

Preferably, in addition to the positional weighting given to query keywords, the query keywords are given relevance weightings dependent upon the perceived relevance of the query keywords to the subject of interest.

Preferably, a subject of interest to the user is represented within the processing means as an interest phrase comprising interest keywords having positional weightings dependent upon the relative positions of the interest keywords within the interest phrase.

Preferably, when the user enters a query phrase, the processing means is arranged to locate an existing interest phrase that satisfies a predetermined degree of correspondence between the query keywords and the interest keywords.

Preferably, the user interface allows the user to select words from the returned interest phrase, and add them to the query phrase.

Preferably, if more than one interest phrase is returned, the phrases are ordered for the user's review in accordance with the degree of correspondence between the query phrase and the interest phrases.

Preferably, the existing interest phrases include interest phrases representative of subjects of interest to other users.

Preferably, when the system is not being used by a given user, the system augments that user's interest phrases by comparing an interest phrase of the given user with interest phrases of other users, and if an interest phrase of another user is sufficiently similar, providing a copy of that interest phrase for the given user.

Preferably, contact information regarding the other user is copied to the given user.

Preferably, links to documents found by the other user are provided for the given user.

Preferably, documents retrieved by the system are selected by the user on the basis of their perceived relevance, and document keywords representative of the selected documents are used to update an interest phrase indicative of an interest of the user

Preferably, the interest phrase is updated by adjusting relevance weightings allocated to interest keywords of the interest phrase.

Suitably, the interest phrase is updated by adding keywords to the interest phrase.

Preferably, the document keywords are used to create a new interest phrase if they are determined not to be relevant to existing interest phrases.

Preferably, the user is requested by the user interface to provide a name for the new interest phrase.

In tandem with the system according to the first aspect of the invention, it is advantageous to provide a method of providing concise summaries of documents to facilitate use of the system.

It is an object of the second aspect of the present invention to provide a new method of summarising the content of a document.

According to a second aspect of the invention there is provided a method of summarising the content of a document, the method comprising segmenting the document into sentences, selecting document keywords from the sentences, and allocating positional weightings to the document keywords dependant upon the relative positions of the document keywords within the sentence.

Preferably, the positional weighting applied to document keywords increases progressively from a low weighting at the beginning of a sentence to a higher weighting at the end of the sentence.

Preferably, the positional weighting increases in a substantially linear manner.

Preferably, the positional weightings applied to document keywords are scaled.

Preferably, where a document keyword occurs more than once in a sentence, the positional weighting is determined on the basis of an average location of the document keyword within the sentence.

Preferably, similar sentences contained in a document are grouped together, and the largest group is taken to be an indication of the average content of the document.

Preferably, a document signature phrase is generated by combining document keywords from each sentence of the group.

Preferably, each document keyword within the document signature phrase is given a relevance weighting dependent upon the number of times it occurs in the group of sentences.

Preferably, the relevance weighting is increased for those document keywords which are capitalised.

A specific embodiment of the invention will now be described by way of example only, with reference to the accompanying figures, in which:

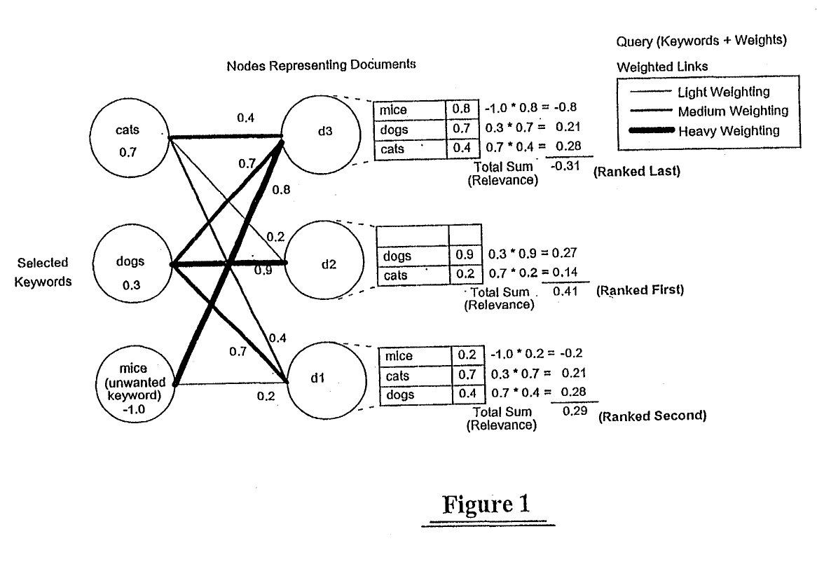

FIG. 1 is a schematic illustration of part of a document retrieval system according to the invention;

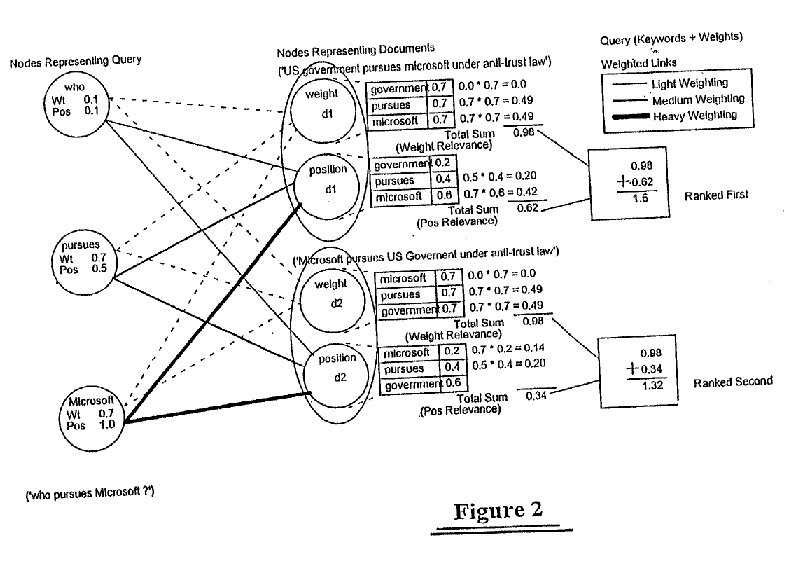

FIG. 2 is a schematic illustration of a document retrieval system according to the invention;

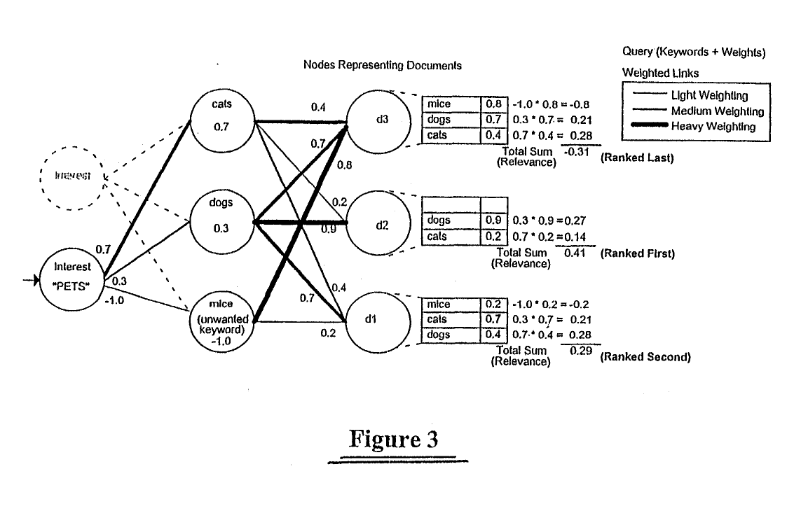

FIG. 3 is a schematic illustration a document retrieval system according to the invention, and including interest nodes; and

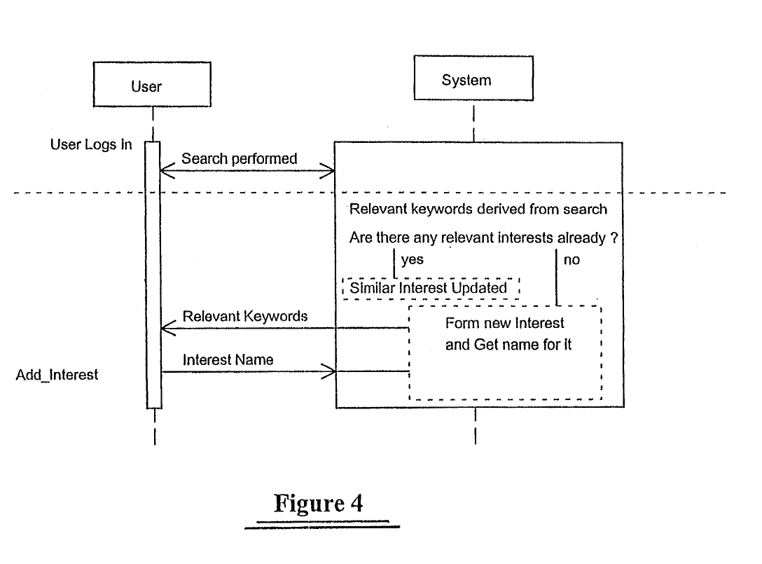

FIG. 4 is a schematic illustration showing how interest nodes are created and updated.

In order to expedite understanding of the document retrieval system according to the invention, the document retrieval system is described in two parts. The first part of the description relates to a document retrieval system which matches query keywords and document keywords irrespective of their location within a document. The second part of the description relates to a document retrieval system according to the invention which, in addition to matching query keywords to document keywords takes account of the relative locations of the keywords.

The document retrieval system shown in FIG. 1 comprises a weighted network of query keywords and document nodes representative of documents. Each document node comprises a set of document keywords indicative of the content of a document.

During information retrieval, the relevance of a document is calculated by multiplying together the weight of a query keyword and the weight of the corresponding document keyword. Where more than one keyword is used, the results of the multiplication are summed together to provide a total measure of the relevance of the document.

Highly weighted query keywords will attenuate only slightly the weights of their document counterparts when multiplication is performed, and documents containing those keywords will be ranked highly in terms of relevance. Conversely, query keywords with low or negative weightings will attenuate the weights of their document counterparts to a much greater degree, with the result that documents are given a lower relevance ranking.

Negative weightings of query keywords are used to provide an inhibitory effect on the retrieval of documents represented by nodes containing those keywords, thus providing the equivalent of a NOT function in Boolean logic.

Referring to FIG. 1, a user wishes to retrieve documents which refer to both cats and dogs, but specifically wants to exclude documents which refer to mice. The user is most interested in cats, and therefore ‘cats’ has a relatively strong weighting of 0.7 (possible weightings range between −1.0 and 1.0). The user is less interested in dogs, and ‘dogs’ has a relatively weak weighting of 0.3. The user is strongly adverse to retrieving documents relating to mice, and ‘mice’ has a strong negative weighting of −1.0.

Each document is represented by a document node containing keywords and associated weightings. For example, the node representative of document d3 has the following keywords and weights: mice 0.8, dogs 0.7, cats 0.4. These document keyword weights are multiplied by the weightings of corresponding query keywords, and a total sum indicative of relevance is calculated for each document. In this case, the most relevant document, as indicated by the largest total sum, is d2.

The method illustrated in FIG. 1 may be represented mathematically as follows:

Given a query Qⱼ=(wⱼ1,wⱼ2, . . . ,wⱼt) and a document Dᵢ=(wᵢ1,wᵢ2, . . . wᵢt), where wⱼ and wᵢ are the weights of the query keywords and document keywords respectively, the similarity is given by:

$$Similarity ( {Q}_{i} , {D}_{i} ) = {\sum }_{k = 1}^{t} {w}_{jk} {w}_{ik}$$

The inventors have realised that the accuracy of document retrieval may be improved greatly by extending the retrieval system to incorporate not just the importance of keywords, but also the relative positions of the keywords. In order to do this, a second network representative of keyword position is added parallel to the network shown in FIG. 1. The combination of the first and second networks is illustrated in FIG. 2, the first network being represented as broken lines and the second network being represented as solid lines.

Rather than providing a relevance measurement based solely upon a ‘bag of words’ (i.e. a set of keywords in any order), the system illustrated in FIG. 2 measures the relevance of documents on the basis of similarities between phrases representing queries and phrases representing documents.

The enhanced measurement of relevance provided by the invention is illustrated by the following example. Consider the following single-phrase documents:

US government pursues Microsoft under their anti-trust laws.

Microsoft pursues the US government under their anti-trust laws.

The query ‘Who pursues Microsoft?’ will produce the same relevance ranking for both documents using a ‘bag of words’ system. Referring to the broken lines of FIG. 2, the two documents are represented as document nodes. The relevance of document d1 is determined in terms of keyword occurrence by multiplying the relevance weighting of each word of the query (i.e. query keywords) with the relevance weighting of each word of the document. In this case the query keywords ‘pursues’ and ‘Microsoft’ have relevance weightings of 0.7 and the query keyword ‘who’ has a relevance weighting of 0.1. The total sum of the relevance weightings for each document is determined, the sum in each case being 0.98. The system fails to identify which of the documents is most relevant to the query, because the relative positions of the words within the phrases are not taken into account.

The system illustrated by the broken lines in FIG. 2 is represented in table format in Table 1.

| Query 1 | | Who | Pursues | Microsoft | | | | |
|---|---|---|---|---|---|---|---|---|
| Weight | | 0.1 | 0.7 | 0.7 | | | | |
| d1 | US | Government | pursues | Microsoft | Under | Anti-Trust | Laws | Score |
| Weight | 0.7 | 0.7 | 0.7 (x0.7) | 0.7 (x0.7) | 0.7 | 0.7 | 0.7 | 0.98 |
| | | | | | | | | 0.98 |
| d2 | Microsoft | pursues | US | Government | Under | Anti-Trust | Laws | |
| Weight | 0.7 (x0.7) | 0.7 (x0.7) | 0.7 | 0.7 | 0.7 | 0.7 | 0.7 | 0.98 |
| | | | | | | | | 0.98 |

Referring to the solid lines in FIG. 2, each word of the query phrase ‘Who pursues Microsoft’ is given a weighting determined by its relative position in the query. In general, the most important words in a query phrase occur towards the end of the phrase. For this reason, the words at the beginning of a phrase are given a low weighting and the words at the end of the phrase are given a high weighting. The weighting increases linearly from the beginning of the phrase to the end of the phrase, and is scaled to values up to 1.0. Scaling prevents the weighting being affected by the length of a query phrase.

The scaling method used scales the positional weighting given to keywords to between −1.0 and 1.0, using the following formula:

$${w}_{i} = {w}_{i} * \frac{1.0}{\vert {w}_{max} \vert}$$

Where wᵢ is the weighting, which may be negative, given to the ith keyword of the phrase, and wₘₐₓ is the number of keywords in the phrase. The relevance weightings given to keywords are scaled in the same way.

Generally, known vector-space analysis methods and document similarity measurement methods, normalise the weights of keywords by using the following formula which produces vectors in which the sum of the keyword weights =1.0:

$${w}_{i} = \frac{{w}_{i}}{\sqrt{{\sum }_{k = 1}^{t} ( {w}_{ik}^{2} )}}$$

However, this formula affects individual weights depending upon the number of keywords within the keyword vector. If a document or interest node contains many keywords, the individual weights of keywords are reduced unnecessarily. Thus, if a small query were used to retrieve documents with keyword vectors of varying lengths, those with few keywords would be retrieved with higher relevance scores than those with large numbers of keywords, thus penalising larger documents. This normalisation method is therefore not used, and the system instead uses the above described scaling method.

Each word of the document is given a weighting determined by its relative position in the document, in the same way as the query phrase.

The query keywords are compared with the documents, the weightngs of corresponding words being multiplied and then added together to provide a total positional weight sum for each document. Referring to FIG. 2, the total positional weight sum for document d1 is 0.77 whereas the total positional weight sum for document d2 is 0.28. Document d1 has a greater total positional weight sum because the word ‘Microsoft’ occurs later in that document, and is consequently given a higher weighting which in turn is multiplied by the high weighting given to the word ‘Microsoft’ in the query phrase.

The combined sum of the positional and relevance weightings is calculated for each document. The combined sum for document d1 is 1.75 whereas the total weighting sum of document d2 is 1.26. Document d1 is therefore determined to be the most relevant. Document d1 is in fact the most relevant because it answers the question ‘who pursues Microsoft?’, whereas d2 does not answer that question.

The system illustrated by the solid lines in FIG. 2 is represented in table format in Table 1.

TABLE 2

| Query 1 | | ‘Who’ | ‘pursues’ | ‘Microsoft’ | | | | Score |
|---|---|---|---|---|---|---|---|---|
| Weight | | 0.1 | 0.7 | 0.7 | | | | |
| Pos | | 0.1 | 0.5 | 1.0 | | | | |
| Doc1 | US | Government | pursues | Microsoft | Under | Anti-Trust | Laws | |
| Weight | 0.7 | 0.7 | 0.7 (x0.7) | 0.7 (x0.7) | 0.7 | 0.7 | 0.7 | 0.98 |
| Pos | 0.14 | 0.28 | 0.42 (x0.5) | 0.56 (x1.0) | 0.7 | 0.84 | 1.0 | 0.77 |
| | | | | | | | | 1.75 |
| Doc2 | Microsoft | pursues | US | Government | Under | Anti-Trust | Laws | |
| Weight | 0.7 (x0.7) | 0.7 (x0.7) | 0.7 | 0.7 | 0.7 | 0.7 | 0.7 | 0.98 |
| Pos | 0.14 (x1.0) | 0.28 (x0.5) | 0.42 | 0.56 | 0.7 | 0.84 | 1.0 | 0.28 |
| | | | | | | | | 1.26 |

As can be seen from the example shown in Table 2, the document most relevant to the query is ranked 1^{st} out of the two possibilities.

The method illustrated in FIG. 2 may be expressed as follows:

Given a query Qⱼ=(wⱼ1,pⱼ1,wⱼ2pⱼ2, . . . , wⱼt,pⱼt) and document Dᵢ=(wᵢ1,pᵢ1,wᵢ2pᵢ2, . . . , wᵢt,pᵢt), where Wⱼ (and pⱼ) and wᵢ (and pᵢ) are the weights (and positions) of the query and document keywords respectively the similarity is given by:

$$Similarity ( {Q}_{i} , {D}_{i} ) = {\sum }_{k = 1}^{t} {w}_{jk} {w}_{ik} + {\sum }_{k = 1}^{t} ( {p}_{jk} {p}_{ik} )$$

In addition to the elements described with reference to FIGS. 2 and 3, the system includes a ‘user-specific’ layer which represents a particular user's interests as ‘interest nodes’, as shown in FIG. 3. Each interest node comprises an ‘interest phrase’ representative of that interest. Weights within the user-specific layer may be adjusted to reflect a user's behaviour without affecting those parts of the system which are common to all users. A user may give his or her own name to an interest node, or provide a phrase descriptive of the interest node. Allowing the user to name interest nodes is advantageous because it introduces the user's own ideas on subject naming and phrasing into the system.

Referring to FIG. 3, a user is interested in cats and dogs, and is specifically not interested in mice. This is reflected in an interest node, designated ‘PETS’ by the user, which includes keywords ‘cats’ and ‘dogs’ with positive weightings, and keyword ‘mice’ with a negative weighting. To avoid over complication the illustration, FIG. 3 does not show keyword weighting on the basis of relative keyword positions. It will be understood however that the interest node does include this ‘positional’ keyword weighting.

When a query keyword phrase is entered by a user, the system tries to match the keywords with a local existing interest node. This is done in the same manner as document retrieval, which is described above and therefore is not described in detail here. When a relevant existing interest node is located, keywords not included in the query are returned from that interest node. The extra keywords are added to the original query, with the user's acquiescence, to provide an enhanced query.

A search is carried out on the basis of the enhanced query. Documents located by the search are listed in order of relevance (i.e. the closest match to the query), and the user selects those documents which are of interest.

The user gives the selected documents relevance ratings on the basis of their perceived relevance to the query. This input by the user is used as ‘feedback’ to update existing interest nodes or create new interest nodes. This is done by gathering keywords from documents with relevance ratings above a predetermined threshold. A new set of keywords is thereby generated comprising those keywords present in the original query and those keywords found in relevant documents.

The weight for each new keyword is calculated as follows:

$${Weight}_{out} = ( {\sum }_{1}^{no\_occ} ( {Weight}_{in\_doc} \times Doc\_Relevance ) )$$

Where ‘no_occ’ is the number of relevant documents the keyword appears in, Weight_{in—doc} is the keyword's weight within a relevant document and Doc_Relevance is the relevance rating assigned to the document by the user. This algorithm calculates the overall relevance of a particular recurring keyword based upon the relevance rating assigned to the document in which it occurs. Thus if it occurs in many relevant documents, its mean weight will be high.

The gathering, of new keywords following a search may be extended to take into account documents deemed irrelevant by the user. Under this extension of the method, documents deemed irrelevant are assigned negative relevance ratings, forcing keywords common to those documents to have negative weightings. These keywords are then combined with the positive keyword set (using an OR function) to provide positive and negative relevant keywords.

One problem with the above method of gathering a new set of relevant keywords is that keywords in an original query (or enhanced query) are not necessarily included in the new set of relevant keywords. The system therefore includes an option to allow ‘Query Keyword Overriding’ which forces the inclusion of the original query terms in the new keyword set, even if they do not appear in the set of keywords generated by the system.

A new keyword phrase is produced which represents an average of the documents selected by the user as being relevant. This new keyword phrase is used to update the user's interest profile. The position weights of new keywords are computed as the average of their position weights within the signatures of documents considered by the user to be relevant.

The use of a new keyword phrase to update a user's interests is shown in FIG. 4. The system attempts to ‘trigger’ an existing interest node or nodes, using the new keyword phrase as a query, in the same manner as document retrieval (which is described above). If this is successful, that interest node is updated based upon the new keyword phrase returned. If a keyword is not already present in the triggered interest node, it is added to that interest node. Existing keywords have their associated weight incremented if they are also found in the new keyword phrase. The size of the increment is predetermined, and determines the rate of learning for that interest node. Existing keywords also have their position weights adjusted to the average of the existing interest keyword position and that of its incoming counterpart. A keyword present in the interest node which is not found in the new keyword phrase will have its associated weighting decremented by a predetermined value.

If a sufficiently close existing interest node cannot be found, a new interest node is created. The user is asked to name the new interest node.

It is already known that user profiling may be further enhanced when a system can ‘unite users with similar interests and effectively share knowledge between them. This approach can increase the competence of software agents (autonomous programs acting on behalf of users) by allowing them to offer each other alternative approaches to the same problem [Maes, P., Agents that Reduce Work and Information Overload, Communications of the ACM, 37(7), (1994)]. Examples of systems that perform this ‘collaborative profiling’ or ‘matchmaking’ are ‘Yenta’ [Foner, L. & Crabtree, I. B. Multi-agent Matchmaking, BT Technology Journal, 14(4), pp115-123, (1996)], a multi-agent system that find people with similar interests and introduces them, and Webhound’ [Lakshari, Y., Metral, M. and Maes, P., Collaborative Interface Agents, In Proceedings of the Twelfth National Conference on Artificial Intelligence, MIT Press, (1994)] that shares ‘know-how’ for information filtering purposes.

By extending the present system to support multiple users, the system is able to unite users with similar interests and, by presenting the differences between these similar ‘interests’, to demonstrate to them subtly different approaches of keyword usage, as well as providing the results of previous searches. This will alert users to the presence of certain keywords they otherwise might not know about. It is important, however, to prevent too many similar interests from being shared, as this could overwhelm the user. The system therefore only shares interests if the level of similarity between the interests falls between certain (user selectable) bounds. This level of similarity is calculated in the same manner as that between documents and queries.

The ‘interest sharing’ process is carried out in two ways. Firstly, pre-search collaboration is used. During query formulation, the system attempts to retrieve a user's interests based on the keywords they are entering (in the same manner as document retrieval). If it is unable to do this (for example, because the user currently has no relevant interests), the system attempts to trigger spheres of interest in other users'profiles, sorting the results by similarity in order to obtain the best possible match for the user. Furthermore, the interests returned are compared with the assistant's existing interests and may be retained for future use if they are deemed similar enough. This approach allows the system to ‘bootstrap’ itself in order to start providing a service more quickly.

The second way in which the ‘interest sharing’ process is carried out is via post-search collaboration. Whilst pre-search collaboration provides ‘emergency help’ for a user, post-search collaboration provides a mechanism for a more generalised learning enhancement. Under this approach, whenever the system is idle, it will attempt to augment each user's profile with interest nodes from other users'profiles. This is carried out by using each interest node in a user's profile to trigger similar interests in other profiles. If the similarity between a user's interest node and those triggered in other profiles falls within ‘sharing constraints’ defined by the user, then it will be added to that user's profile, together with information such as the other user's email address to facilitate personal contact, as well as direct links to the documents found useful by the other user. This form of collaboration is intended to provide the opportunity to unite similar users, present ideas for ‘different’ searches and to determine whether the search proposed by a user has already been carried out by another user (by offering the results of previous searches).

When the system is not in use, a user's set of interests are used in order to perform a search proactively using simple genetic algorithms. A ‘cross-section’ of the interest set is taken by extracting the highest weighted keywords from the set as this reflects the subjects in which the user is ‘most interested’. The system then carries out a search using these keywords and presenting the resulting documents for review when the user next logs in. Various constraints are proposed in order to avoid repeated recommendation of the same documents. For example, the width of the cross-section could be limited to a subset of the n most recently modified interest spheres (indicating current interests). Successive proactive searches may be made to sample keywords from different subsets of the interest spheres, by either cycling through them or by random selection.

The following is a method of summarising the content of documents as keyword phrases suitable for use in connection with the method described above.

The method is based upon the known method of indexing documents by finding the most frequently occurring keywords and assigning weight values to them, based upon their frequency of occurrence within a specific document versus their overall frequency of occurrence in the document collection. This method is known as Term Frequency * Inverse Document Frequency (TF/IDF) [Salton & McGill, Introduction to Modem Information Retrieval, 1983]. The TF/IDF method breaks documents down into keywords, counting the frequency of the keywords to produce a vector of weighted keywords.

The new summarising method provides a phrase signature comprising an ordered set of weighted keywords representing the ‘average of the phrases contained within the document’. It is believed that this method provides for each document, an indication of the major scope or ‘gist’ of its contents.

The method consists of (for each document):

1. Segmentation of the document into sentences. The document is broken down into sentences using punctuation and layout as a guide. This produces a set of abstract phrases.

2. Conversion of each phrase into a ‘phrase neuron’. Each sentence is scanned and transformed into a ‘phrase neuron’ representing the keywords within that sentence (minus closed-class keywords such as ‘and’ and ‘the’). During this conversion process, term weights are allocated based upon their frequency within the phrase, whether or not they are capitalised (a capitalised term would indicate a proper noun or an emphasis) and the overall status of the phrase within the document; for example, the terms in a title or heading phrase. receive higher weightings than those within a text body. The position weights are simply allocated by the order of the words within the phrase. For example terms ‘the cat sat on the mat’ would receive weights of 1,2 and 3 for ‘cat’, ‘sat’ and ‘mat’ respectively. Where a term occurs more than once in a phrase, the position weight is the average of its absolute positions. In line with standard neural network practices, and to prevent long sentences from gaining a weight advantage over shorter phrases, both frequency and position weights are scaled to between 0 and 1.

3. Clustering of similar phrases within the document. Following standard methods of extraction-based summarisation [Salton & Singhal, The automatic Text Theme Generation and the Analysis of Text Structure, Cornell University Technical Report TR 94-1438, 1994], all phrases extracted from the document are clustered into sets of similar phrases. Within this approach this is achieved by using each phrase to trigger every other phrase within the document. Thus each phrase will produce a variably sized set of ‘similar’ phrases. The largest of these sets is taken to be an indication of the ‘average content’ of the document. The final stage in producing the summary is to sort these phrases into their original order within the document.

4. Averaging of the resultant phrase set into a document signature. The final task in indexing the document is the production of the signature itself. This involves producing a set of weighted keywords representing the aggregate of the phrases in the summary set. This is achieved by taking each phrase and adding the keywords present to the signature. If a keyword is already present in the signature then its position weight is computed as the average of its position in the signature and its position in the phrase. In order to allow for more variation in the frequency weights of keywords in the signature, it is proposed that the frequency weight of each keyword be calculated as its total frequency in the summary. Therefore, rather than averaging the frequency weights in the same manner as the positions, the frequency weight of each keyword in each phrase is added to its frequency in the signature. Finally the weights within the signature are scaled to between 0 and 1.0 in order to constrain their values.

Variables that may be used to affect the above described method include varying the trigger threshold of the phrase neurons to produce differently sized summary phrase sets, influencing the phrases contained in the phrase sets by centring the clustering around a ‘centre phrase’. This could be used to pick out important points from documents when indexing within a domain-specific context. For example if the system were indexing curricula vitae, a centre phrase of ‘research interests hobbies include’ would force the indexing of phrases connected with document creator's research interests and hobbies. A further variable comprises introducing an upper threshold to similarity above which neurons will not fire. This would enable wider coverage of the clustering process by avoiding inclusion of very similar or repeated phrases and hence phrase duplication and redundancy.

Experiments with the novel method have shown very promising results, for example consider the following:

Original document: Manchester Metropolitan Students Union. Manchester Metropolitan Students Union Welcome to Manchester Metropolitan Students'Union With over 30,000 students, Manchester Metropolitan University is the largest in the country, with the Students'Union at the heart of its social, cultural and sporting life. You can find out anything to do with the Students'Union—Check out what's going on at each campus, check what is happening with your favourite club and much more! Unfortunately, the browser you are using does not support frames, but please check back soon for a text version. Alternatively, update your browser so you can see the site in its full glory!

Summary: Manchester Metropolitan Students Union. Manchester Metropolitan Students Union Welcome to Manchester Metropolitan Students'Union With over 30,000 students, Manchester Metropolitan University is the largest in the country, with the Students'Union at the heart of its social, cultural and sporting life.

Document Signature: manchester, welcome, metropolitan, 30 000, students, union, university, largest, country, heart social, cultural, sporting, life,

In the above example, each sentence was extracted, and converted into a ‘dual vector’ representing the keyword weights and keyword positions. The sentences were then clustered into sets of similar sentences by comparing each sentence with every other sentence in the source document. The largest cluster of similar sentences was identified, and the original sentence order was reassembled to generate the summary. The document signature was produced by taking keywords from the summary sentences.

The summarising method described above is not intended to provide a comprehensive abstract of the document, but rather an indication of its main salient content. There may be methods of document summarising technology that are able to provide more effective summaries or abstracts of text documents. However, these tend to involve linguistic processing which makes them domain/language dependent.

The system provides a networked approach to the retrieval of documents, whereby documents are related to keywords by a double network of weighted links, These weights allow both the significance and position of both document and query keywords to be used in retrieval. This approach provides both highly accurate ranked retrieval as well as a suitable platform for a novel document summarisation and indexing technique and intrinsic support for interactive user level components of the system, such as query by reformulation and user profiling.

1. A document retrieval system comprising a user interface and processing means, wherein the user interface is configured to allow a user to enter a query phrase indicative of a subject of interest, and the processing means is operative to select query keywords from the query phrase and allocate positional weightings to the query keywords dependent upon the relative positions of the query keywords within the query phrase.

2. A document retrieval system according to claim 1, wherein the positional weighting applied to query keywords increases progressively from a low weighting. at the beginning of the query phrase to a higher weighting at the end of the query phrase.

3. A document retrieval system according to claim 2, wherein the positional weighting increases in a substantially linear manner.

4. A document retrieval system according to any of claims 1 to 3, wherein the positional weightings applied to the query keywords are scaled.

5. A document retrieval system according to claim 4, wherein the scaling is such that the maximum query keyword positional weighting is one.

6. A document retrieval system according to any preceding claim, wherein the system is arranged to compare the query phrase with a set of document signature phrases, each document signature phrase being indicative of the contents of a document.

7. A document retrieval system according to claim 6, wherein each document signature phrase comprises document keywords having positional weightings dependent upon their relative positions within the document signature phrase.

8. A document retrieval system according to claim 7, wherein comparison of the query phrase and the document signature phrase comprises multiplying the positional weighting of each query keyword by the positional weighting of a corresponding document keyword.

9. A document retrieval system according to claim 8, wherein the results of the multiplication are added together to provide a sum that is a measure of the relevance of the document represented by the document signature phrase.

10. A document retrieval system according to any preceding claim, wherein in addition to the positional weighting given to query keywords, the query keywords are given relevance weightings dependent upon the perceived relevance of the query keywords to the subject of interest.

11. A document retrieval system according to any preceding claim, wherein a subject of interest to the user is represented within the processing means as an interest phrase comprising interest keywords having positional weightings dependent upon the relative positions of the interest keywords within the interest phrase.

12. A document retrieval system according to claim 11, wherein when the user enters a query phrase, the processing means is arranged to locate an existing interest phrase that satisfies a predetermined degree of correspondence between the query keywords and the interest keywords.

13. A document retrieval system according to claim 12, wherein the user interface allows the user to select words from the returned interest phrase, and add them to the query phrase.

14. A document retrieval system according to claim 12 or claim 13, wherein if more than one interest phrase is returned, the phrases are ordered for the user's review in accordance with the degree of correspondence between the query phrase and the interest phrases.

15. A document retrieval system according to any of claims 12 to 14, wherein the existing interest phrases include interest phrases representative of subjects of interest to other users.

16. A document retrieval system according to any of claims 12 to 15, wherein when the system is not being used by a given user, the system augments that user's interest phrases by comparing an interest phrase of the given user with interest phrases of other users, and if an interest phrase of another user is sufficiently similar, providing a copy of that interest phrase for the given user.

17. A document retrieval system according to claim 16, wherein contact information regarding the other user is copied to the given user.

18. A document retrieval system according to claim 16 or claim 17, wherein links to documents found by the other user are provided for the given user.

19. A document retrieval system according to any preceding claim, wherein documents retrieved by the system are selected by the user on the basis of their perceived relevance, and document keywords representative of the selected documents are used to update an interest phrase indicative of an interest of the user.

20. A document retrieval system according to claim 19, wherein the interest phrase is updated by adjusting relevance weightings allocated to interest keywords of the interest phrase.

21. A document retrieval system according to claim 19 or claim 20, wherein the interest phrase is updated by adding keywords to the interest phrase.

22. A document retrieval system according to any of claims 19 to 21, wherein the document keywords are used to create a new interest phrase if they are determined not to be relevant to existing interest phrases.

23. A document retrieval system according to claim 22, wherein the user is requested by the user interface to provide a name for the new interest phrase.

24. A method of summarising the content of a document, the method comprising segmenting the document into sentences, selecting document keywords from the sentences, and allocating positional weightings to the document keywords dependant upon the relative positions of the document keywords within the sentence.

25. A method according to claim 24, wherein the positional weighting applied to document keywords increases progressively from a low weighting at the beginning of a sentence to a higher weighting at the end of the sentence.

26. A method according to claim 25, wherein the positional weighting increases in a substantially linear manner.

27. A method according to claim 26, wherein the positional weightings applied to document keywords are scaled.

28. A method according to any of claims 24 to 27, wherein where a document keyword occurs more than once in a sentence, the positional weighting is determined on the basis of an average location of the document keyword within the sentence.

29. A method according to any of claims 24 to 28, wherein similar sentences contained in a document are grouped together, and the largest group is taken to be an indication of the average content of the document.

30. A method according to claim 29, wherein a document signature phrase is generated by combining document keywords from each sentence of the group.

31. A method according to claim 30, wherein each document keyword within the document signature phrase is given a relevance weighting dependent upon the number of times it occurs in the group of sentences.

32. A method according to claim 31, wherein the relevance weighting is increased for those document keywords which are capitalised.

33. A document retrieval system substantially as hereinbefore described with reference to the accompanying figures.

34. A method of summarising the content of a document substantially as hereinbefore described.
